(19) United States
(12) Patent Application Publication
(10) Pub. No.: US 2026/0249611 A1
(43) Pub. Date: Aug. 27, 2026

(54) LIQUID DISCHARGE HEAD, LIQUID DISCHARGE UNIT, AND LIQUID DISCHARGE APPARATUS

(71) Applicants: Keishi MIWA, Kanagawa (JP); Toshiaki MASUDA, Kanagawa (JP)

(72) Inventors: Keishi MIWA, Kanagawa (JP); Toshiaki MASUDA, Kanagawa (JP)

(21) Appl. No.: 19/543,929

(22) Filed: Feb. 19, 2026

(30) Foreign Application Priority Data
Feb. 25, 2025 (JP) 2025-027886

(51) Int. Cl. B41J 2/14; B41J 2/16

(52) U.S. Cl. CPC B41J 2/14233; B41J 2/161; B41J 2/1623; B41J 2202/11

(57) ABSTRACT

A liquid discharge head includes a nozzle plate, a piezoelectric element substrate, a functional substrate, and a common channel substrate. The nozzle plate has multiple nozzles to discharge a liquid in a discharge direction. The piezoelectric element substrate is bonded to the nozzle plate. The piezoelectric element substrate includes: multiple individual chambers; a diaphragm; and multiple piezoelectric elements on the diaphragm. The piezoelectric element substrate has: a first linear expansion coefficient; and bending portions disposed at each end or at each corner of the piezoelectric element substrate. The bending portions bend in the discharge direction. The functional substrate has a first face bonded to the piezoelectric element substrate. The common channel substrate is bonded to a second face opposite to the first face of the functional substrate. The common channel substrate has a second linear expansion coefficient larger than the first linear expansion coefficient of the piezoelectric element substrate.

### CROSS-REFERENCE TO RELATED APPLICATION

This patent application is based on and claims priority pursuant to 35 U.S.C. § 119(a) to Japanese Patent Application No. 2025-027886, filed on Feb. 25, 2025, in the Japan Patent Office, the entire disclosure of which is hereby incorporated by reference herein.

### BACKGROUND

### Technical Field

The present disclosure relates to a liquid discharge head, a liquid discharge unit, and a liquid discharge apparatus.

### Related Art

In the related art, actuators for an inkjet head, which is a liquid discharge head that discharges a liquid, are formed on a silicon substrate at high density by a micro electro mechanical systems (MEMS) process. In such actuators, a diaphragm is formed so as to cover pressure liquid chambers, and piezoelectric elements are disposed on the diaphragm.

### SUMMARY

The present disclosure described herein provides an improved liquid discharge head including a nozzle plate, a piezoelectric element substrate, a functional substrate, and a common channel substrate. The nozzle plate has multiple nozzles to discharge a liquid in a discharge direction. The piezoelectric element substrate is bonded to the nozzle plate. The piezoelectric element substrate includes: multiple individual chambers respectively communicating with the multiple nozzles; a diaphragm facing the multiple individual chambers; and multiple piezoelectric elements on the diaphragm. The multiple piezoelectric elements respectively correspond to the multiple individual chambers. The piezoelectric element substrate has: a first linear expansion coefficient; and bending portions disposed at each end or at each corner of the piezoelectric element substrate. The bending portions bend in the discharge direction. The functional substrate has a first face bonded to the piezoelectric element substrate. The common channel substrate is bonded to a second face opposite to the first face of the functional substrate. The common channel substrate has a second linear expansion coefficient larger than the first linear expansion coefficient of the piezoelectric element substrate.

Further, the present disclosure described herein provides an improved head manufacturing method including: applying adhesive on four corners of a common channel substrate; laminating the common channel substrate on a functional substrate; laminating the functional substrate on a piezoelectric element substrate; laminating the piezoelectric element substrate on a nozzle plate; applying a first load to a lamination of the common channel substrate, the functional substrate, the piezoelectric element substrate, and the nozzle plate to bond the of the common channel substrate, the functional substrate, the piezoelectric element substrate, and the nozzle plate with the adhesive; and applying a second load larger than the first load to the lamination after applying the first load to the lamination to deform each end of the piezoelectric element substrate to form bending portions bending toward the nozzle plate.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic exploded perspective view of a liquid discharge unit;

FIG. 2 is a schematic cross-sectional view of the liquid discharge unit of FIG. 1 in a transverse direction of a liquid discharge head;

FIG. 3 is a cross-sectional view of a liquid discharge head according to a comparative example;

FIG. 4 is a bottom view of the liquid discharge head of FIG. 3 as viewed from a nozzle substrate side in a discharge direction;

FIGS. 5A and 5B are cross-sectional diagrams illustrating processes of manufacturing, for example, the liquid discharge head of FIG. 3, according to the comparative example;

FIG. 6 is a cross-sectional view of the liquid discharge head of FIG. 3, according to the comparative example, as a part (a), and an enlarged cross-sectional view of a piezoelectric element substrate and the surroundings thereof, enclosed by the solid rectangular frame in the part (a), as a part (b);

FIG. 7 is a cross-sectional view of a first example of a liquid discharge head, as a part (a), and an enlarged cross-sectional view of a piezoelectric element substrate and the surroundings thereof, enclosed by the solid rectangular frame in the part (a), as a part (b);

FIG. 8 is an enlarged cross-sectional view of a portion of the first example enclosed by the dashed rectangular frame in the part (a) of FIG. 7, when a corner adhesive is cured in a specific shape;

FIGS. 9A and 9B are cross-sectional diagrams illustrating processes of manufacturing the first example of the liquid discharge head of FIG. 7;

FIG. 10 is a cross-sectional diagram illustrating a warpage of the first example of the liquid discharge head of FIG. 7, which is exaggerated;

FIG. 11 is an enlarged cross-sectional view of a portion of a second example of a liquid discharge head;

FIG. 12 is a bottom view of a third example of a liquid discharge head as viewed from a nozzle substrate side in a discharge direction; and

FIG. 13 is a schematic front view of a printer including a liquid discharge head.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In a comparative example, actuators for an inkjet head, which is a liquid discharge head that discharges a liquid, are formed on a silicon substrate at high density by a micro electro mechanical systems (MEMS) process. In such actuators, a diaphragm is formed so as to cover pressure liquid chambers, and piezoelectric elements are disposed on the diaphragm.

In the assembly of the inkjet head, an actuator substrate, which may be referred to as a piezoelectric element substrate including the piezoelectric elements and the diaphragm, is assembled to a channel member with an adhesive. The linear expansion coefficient of a resin channel member (i.e., a second linear expansion coefficient) is larger than the linear expansion coefficient of a silicon (Si) actuator substrate (i.e., a first linear expansion coefficient). As a result, when a thermosetting adhesive is used to obtain ink resistance, residual stress due to the difference in linear expansion coefficient remains in the actuator substrate after the thermosetting adhesive is heated and cured, and the residual stress is constantly applied to the actuator substrate. In particular, the magnitude of the residual stress is different between the central portion and the end portion of the inkjet head, and the linear expansion coefficient of the resin channel member is larger than that of the silicon actuator substrate. Thus, a large compressive stress is applied to the central portion of the diaphragm, and a small compressive stress is applied to the end portion.

When such residual stress is applied, the applied compressive stress is different between the central portion and the end portion of the actuator substrate (e.g., the diaphragm of the piezoelectric element substrate). Accordingly, the inkjet head has a different performance of the discharge speed between the central portion and the end portion.

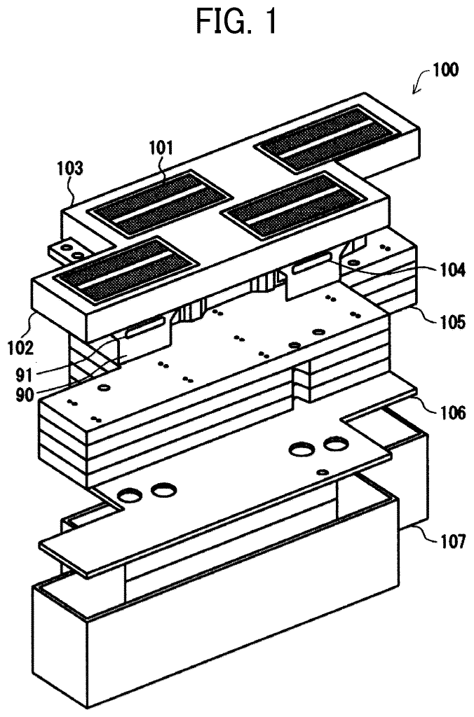

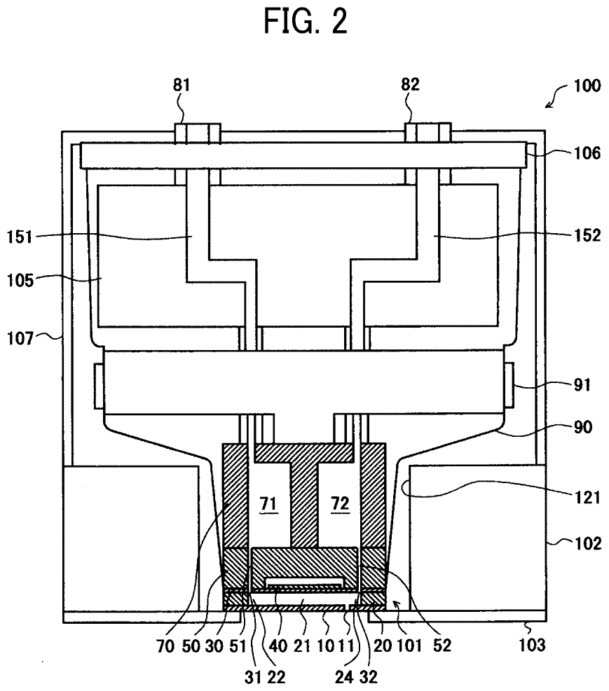

FIG. 1 is a schematic exploded perspective view of a liquid discharge unit 100. FIG. 2 is a schematic cross-sectional view of the liquid discharge unit 100 illustrated in FIG. 1 in a transverse direction of a liquid discharge head. The liquid discharge unit may be referred to as a liquid discharge module including multiple liquid discharge heads. In the following description, a specific example of the liquid discharge head includes, but is not limited to, an inkjet head that discharges ink as a liquid.

In FIG. 1, the liquid discharge unit 100 includes multiple liquid discharge heads 101 that discharge a liquid (e.g., ink), a base 102 that holds the multiple liquid discharge heads 101, and a cover 103 serving as a nozzle cover that covers the multiple liquid discharge heads 101. The liquid discharge unit 100 further includes a heat dissipator 104, a manifold 105 defining channels to supply the liquid to the multiple liquid discharge heads 101, a printed circuit board (PCB) 106 connected to a flexible wiring 90 including a driver integrated circuit (IC) 91, and a module case 107.

As illustrated in FIG. 2, each of the multiple liquid discharge heads 101 includes a nozzle substrate 10 (i.e., a nozzle plate), a channel substrate 20, a diaphragm 30, a piezoelectric element holding substrate 50, and a common channel substrate 70 which may be referred to as a frame. Multiple nozzles 11 are arrayed on a surface of the nozzle substrate 10, from which a liquid is discharged, in a longitudinal direction orthogonal to the transverse direction, to discharge the liquid in a discharge direction orthogonal to the longitudinal direction and the transverse direction. The channel substrate 20 defines individual liquid chambers 21 communicating with the nozzles 11, respectively. The diaphragm 30 includes piezoelectric elements 40. The piezoelectric element holding substrate 50 is laminated over the diaphragm 30. The common channel substrate 70 is laminated over the piezoelectric element holding substrate 50.

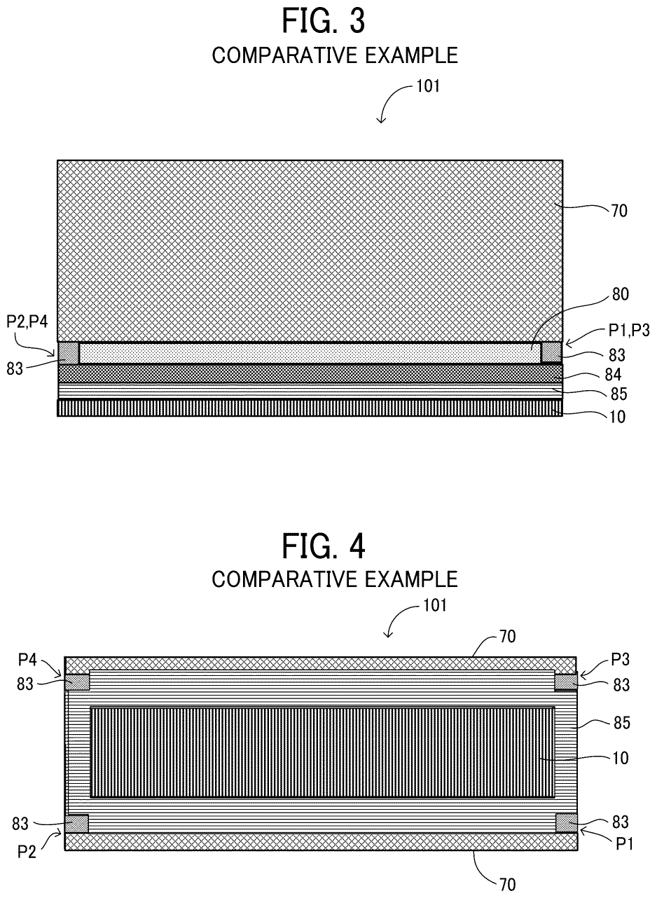

A functional substrate, such as a damper that absorbs pressure when liquid (ink) is discharged and a damper holding substrate that holds the damper, may be disposed between a piezoelectric element substrate and the common channel substrate 70 (see FIG. 3 described later). Illustrations of the damper and the damper holding substrate are omitted in FIG. 2. Components from the channel substrate 20 to the piezoelectric element holding substrate 50 may be collectively referred to as a piezoelectric element substrate, but the piezoelectric element holding substrate 50 may be referred to as the functional substrate.

As illustrated in FIG. 2, in addition to the individual liquid chambers 21, the channel substrate 20 defines supply-side individual channels 22 communicating with the individual liquid chambers 21 and collection-side individual channels 24 communicating with the individual liquid chambers 21, respectively. The piezoelectric element holding substrate 50 defines supply-side intermediate individual channels 51 and collection-side intermediate individual channels 52. The supply-side intermediate individual channels 51 communicate with the supply-side individual channels 22 via openings 31 of the diaphragm 30, respectively. The collection-side intermediate individual channels 52 communicate with the collection-side individual channels 24 via openings 32 of the diaphragm 30, respectively.

The common channel substrate 70 (i.e., the frame) defines a supply-side common channel 71 and a collection-side common channel 72. The supply-side common channel 71 communicates with the supply-side intermediate individual channels 51. The collection-side common channel 72 communicates with the collection-side intermediate individual channels 52. The supply-side common channel 71 communicates with a supply port 81 via a manifold supply channel 151 of the manifold 105. The collection-side common channel 72 communicates with a collection port 82 via a manifold collection channel 152 of the manifold 105.

As illustrated in FIG. 1, the PCB 106 and the piezoelectric element 40 of the liquid discharge head 101 are connected to each other via the flexible wiring 90, and the driver IC 91 is mounted on the flexible wiring 90.

In FIG. 1, the multiple liquid discharge heads 101 are mounted onto the base 102 with a space between the liquid discharge heads 101. The liquid discharge head 101 is inserted into an opening 121 in the base 102, and the peripheral end of the nozzle substrate 10 (see FIG. 2) of the liquid discharge head 101 is bonded and fixed to the cover 103, which is bonded and fixed to the base 102, to attach the liquid discharge head 101 to the base 102.

A flange disposed outside the common channel substrate 70 of the liquid discharge head 101 is bonded and fixed to the base 102. A structure for fixing the liquid discharge head 101 to the base 102 is not limited to the above-described structure. The liquid discharge head 101 may be fixed to the base 102 by, for example, bonding, swaging, riveting, or screwing.

The base 102 illustrated in FIGS. 1 and 2 is preferably made of a material having a low coefficient of linear expansion. For example, 42Alloy, which is an alloy of iron with nickel including 42% nickel, or an invar material may be used as the material having a low coefficient of linear expansion. In the present embodiment, the invar material is used.

With such a configuration, the liquid discharge head 101 can reduce a displacement of the nozzles 11 from a predetermined nozzle position to reduce a deviation of a landing position of a liquid discharged from the nozzles 11 of the liquid discharge head 101 even if the temperature of the base 102 is increased by heat generated by the liquid discharge head 101 since an amount of thermal expansion of the base 102 is small.

Similarly, each of the nozzle substrate 10, the channel substrate 20, and the diaphragm 30 is formed of a silicon single-crystal substrate, and has substantially the same coefficient of linear expansion as that of the base 102. This configuration can reduce the displacement of the nozzle 11 caused by thermal expansion.

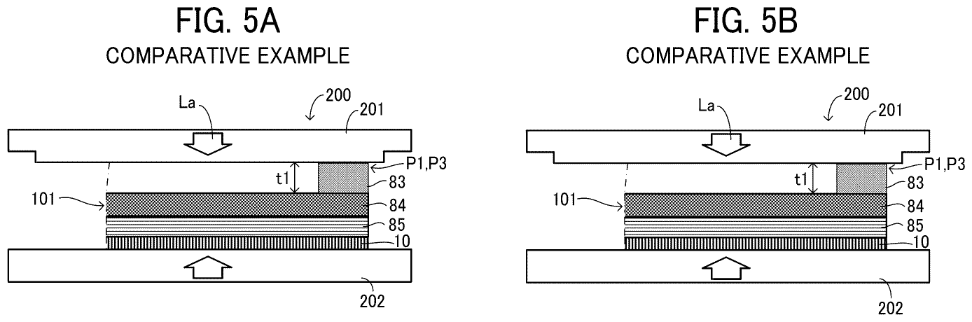

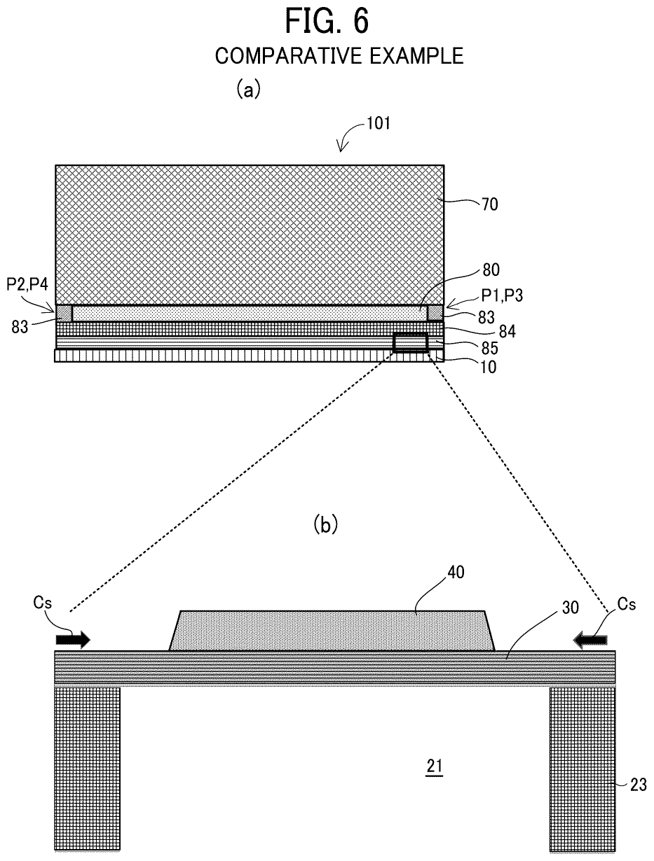

A description is given below of a liquid discharge head according to a comparative example with reference to FIGS. 3 to 6. FIG. 3 is a schematic cross-sectional view of the liquid discharge head according to the comparative example. FIG. 4 is a schematic plan view of the liquid discharge head of FIG. 3 as viewed from a nozzle substrate side in a liquid discharge direction. FIGS. 5A and 5B are cross-sectional diagrams illustrating processes of manufacturing, for example, the liquid discharge head of FIG. 3, according to the comparative example. A part (a) of FIG. 6 is a cross-sectional view of the liquid discharge head of FIG. 3, according to the comparative example, and a part (b) of FIG. 6 is an enlarged cross-sectional view of a piezoelectric element substrate and the surroundings thereof, enclosed by the solid rectangular frame in the part (a).

Corner adhesives 83 are disposed at four corners P1 to P4 inside the outer periphery of the liquid discharge head 101 in FIGS. 3 to 5. The corner adhesives 83 are indicated by fine crosshatching, which depicts the shape of the corner adhesive 83 cured by irradiation of ultraviolet (UV) light, in FIGS. 3 to 5.

As illustrated in FIG. 3, the liquid discharge head 101 according to the comparative example includes the nozzle substrate 10 (i.e., the nozzle plate), a piezoelectric element substrate 85, a damper 84, a damper holding substrate 80, and the common channel substrate 70, which are bonded to each other with adhesives in this order from the bottom to the top in FIG. 3. The piezoelectric element substrate 85 includes the channel substrate 20 including the individual liquid chambers 21, the diaphragm 30, and the piezoelectric elements 40 on the diaphragm 30. The piezoelectric element substrate 85 is bonded to the nozzle substrate 10. The damper 84 and the damper holding substrate 80 may be collectively referred to as the functional substrate. Further, the functional substrate may include the piezoelectric element holding substrate 50. In FIG. 3, illustrations of the adhesives, such as thermosetting adhesives (i.e., a first type of adhesive) other than the corner adhesives 83 made of a UV curable adhesive (i.e., a second type of adhesive), are omitted for the sake of simplicity of the drawing. The same applies to the other drawings illustrating examples described later.

The nozzle substrate 10, the piezoelectric element substrate 85, and the damper holding substrate 80 include a silicon (Si) material. These silicon substrates are patterned by photolithography, and fine patterns are formed by wet etching or dry etching. The damper 84 includes a material containing nickel (Ni) and is formed by plating.

The common channel substrate 70 is formed of a thermoplastic resin material, such as polyphenylene sulfide (PPS), polypropylene (PP), or glass epoxy resin, which may be referred to as a resin material member. When a silicon (Si) material member and the resin material member are bonded and joined to each other, a thermosetting epoxy-based adhesive, which may be referred to as a thermosetting adhesive in the following description, having high ink resistance is used.

To join the resin material member and the silicon material member with high accuracy, a strong load, e.g., 100 N, is applied to the resin material member and the silicon material member, and the resin material member and the silicon material member are heated to cure the thermosetting adhesive so as to prevent ink leakage.

The process performed at this time includes first to fifth steps. In the first step, a thermosetting adhesive is applied to the outer peripheral portion of the common channel substrate 70. In the second step, a UV curable adhesive is applied to the four corners of the outer periphery of the common channel substrate 70 in plan view. In the third step, the common channel substrate 70 and the silicon material member are aligned with each other, and a strong load is applied to the common channel substrate 70 and the silicon material member. In the fourth step, the UV curable adhesive applied to the four corners of the common channel substrate 70 is irradiated with UV light to cure only the four corners. In the fifth step, the thermosetting adhesive is cured by heating with the strong load applied to the opposed faces between the members (the piezoelectric element substrate 85, the damper 84, the damper holding substrate 80, and the common channel substrate 70), which construct the liquid discharge head 101.

The first to fifth steps described above are performed in parallel. As illustrated in FIGS. 3 and 4, in the first and second steps, the thermosetting adhesive is applied to the outer peripheral portion of the common channel substrate 70, and the UV curable adhesive (which becomes the corner adhesive 83 indicated by fine crosshatching after being cured by the irradiation of UV light) is applied to the four corners P1 to P4 of the rectangular outer periphery of the common channel substrate 70 in plan view.

As illustrated in FIGS. 3 and 4, the four corners P1 to P4 are set on the outer side so as not to interfere with, for example, the region where an ink channel is formed (this is the same in the examples described later).

In the third step, the resin material member (the common channel substrate 70) and the silicon material member (the laminated substrate members such as the piezoelectric element substrate 85 and the damper holding substrate 80) are aligned, the strong load is applied, and the UV adhesive is cured by the irradiation of UV light, as described later, before the thermosetting adhesive is thermally cured, to prevent the positions of the members from being shifted by pressurization or heating.

A detailed description is given below of the third to fifth steps with reference to FIGS. 5A and 5B. In FIGS. 5A and 5B, illustrations of the common channel substrate 70 and the damper holding substrate 80 of the liquid discharge head 101, according to the comparative example, sandwiched between an upper stage 201 and a lower stage 202 of a load applying device 200 are omitted. In the corner adhesives 83, which are indicated by fine crosshatching, applied to the four corners of the outer periphery of the common channel substrate 70, illustrations of the corner adhesives 83 at the two corners P1 and P3 on the right side are enlarged and emphasized, and the illustrations of the corner adhesives 83 at the two other corners P2 and P4 on the left side are omitted (the same applies to the examples described later).

In the third to fifth steps, when the corner adhesives 83 applied to the four corners P1 to P4 of the common channel substrate 70 are irradiated with UV light to cure the corner adhesives 83 and temporarily fix the members, the load applying device 200 illustrated in FIG. 5A is used. First, during the manufacturing of the liquid discharge head 101 according to the comparative example, the liquid discharge head 101 having the uncured corner adhesives 83 is placed and fixed between the upper stage 201 and the lower stage 202 of the load applying device 200 illustrated in FIG. 5A, and a load is applied to the liquid discharge head 101.

In FIG. 5A, the corner adhesives 83 made of the UV curable adhesive applied to the four corners P1 to P4 are irradiated with UV light emitted from a UV irradiator to cure the corner adhesives 83 instantly. At this time, the corner adhesives 83 are cured by the irradiation of UV light while a strong load La (a load stronger than that in the examples described later) is applied between the upper stage 201 and the lower stage 202. Accordingly, the cured corner adhesives 83 are compressed by a large amount due to the strong load La, and as a result, the corner adhesives 83 at the four corners P1 to P4 are cured in a thin thickness t1.

Subsequently, in FIG. 5B after the elapsed time from FIG. 5A, while the strong load La similar to that illustrated in FIG. 5A is applied to the corner adhesives 83 at the four corners P1 to P4 of the liquid discharge head 101, the corner adhesives 83 have been cured, and the thickness t1 does not change. The strong load La similar to that of the temporary fixing is also applied to the respective members (the piezoelectric element substrate 85, the damper 84, the damper holding substrate 80, and the common channel substrate 70) constructing the liquid discharge head 101, other than the corner adhesives 83 at the four corners P1 to P4. Accordingly, the thickness t1 of the corner adhesive 83 does not change. As a result, the cross-sectional shape of the cured corner adhesive 83 is maintained with the portion other than the corner adhesive 83 not deformed.

In the fifth step, to bond and fix the unfinished product of the liquid discharge head 101, which is temporarily bonded, by the permanent bonding, the thermosetting adhesive applied between the opposed faces of the respective members (the piezoelectric element substrate 85, the damper 84, the damper holding substrate 80, and the common channel substrate 70) constructing the liquid discharge head 101 is heated while the strong load La is applied to the thermosetting adhesive to cure the thermosetting adhesive. At this time, the liquid discharge head 101 after curing has residual stress due to a difference in linear expansion coefficient between the resin material member and the silicon material member.

In the configuration of the liquid discharge head 101 according to the comparative example, when the common channel substrate 70, which is the resin material member having a large linear expansion coefficient and has been greatly expanded during heating, returns to room temperature, the nozzle substrate 10, the piezoelectric element substrate 85, and the damper holding substrate 80, which are silicon material members, are compressed by the common channel substrate 70. Accordingly, the central portion of the silicon material members (the nozzle substrate 10, the piezoelectric element substrate 85, and the damper holding substrate 80) receives a strong compressive stress, and the end portion of the silicon material members receives a weak compressive stress.

When the piezoelectric element substrate 85, which is the silicon material member, receives the compressive stress, the diaphragm 30 in the piezoelectric element substrate 85 is loosened, and thus, the displacement of the piezoelectric element 40 is increased as compared with that of the piezoelectric element 40 not receiving the compressive stress. As a result, the ink discharge speed may be increased.

Further description is given below of the liquid discharge head according to the comparative example with reference to FIG. 6. The part (a) of FIG. 6 is a cross-sectional view of the liquid discharge head of FIG. 3, according to the comparative example, and the part (b) of FIG. 6 is an enlarged cross-sectional view of a piezoelectric element substrate and the surroundings thereof, enclosed by the solid rectangular frame in the part (a). As illustrated in the part (b) of FIG. 6B, several hundreds to several thousands of piezoelectric elements 40 are disposed in the left-right direction of the part (a) of FIG. 6 (i.e., the longitudinal direction orthogonal to the transverse direction of the liquid discharge head 101).

The piezoelectric element substrate 85 receives a compressive stress Cs stronger at the central portion than at the end portion. Accordingly, the ink discharge speed is high in the central portion of the piezoelectric element substrate 85, and the ink discharge speed is low in the end portion of the piezoelectric element substrate 85. As illustrated in the part (b) of FIG. 6, weak compressive stresses Cs indicated by the thin arrows are applied to the piezoelectric element 40 at the end portion of the piezoelectric element substrate 85. As a result, the ink discharge speed may largely vary in the entire liquid discharge head 101.

To solve such a situation, a compressive stress stronger than that in the above-described configuration according to the comparative example is applied to the end portion of the piezoelectric element substrate 85.

### First Example

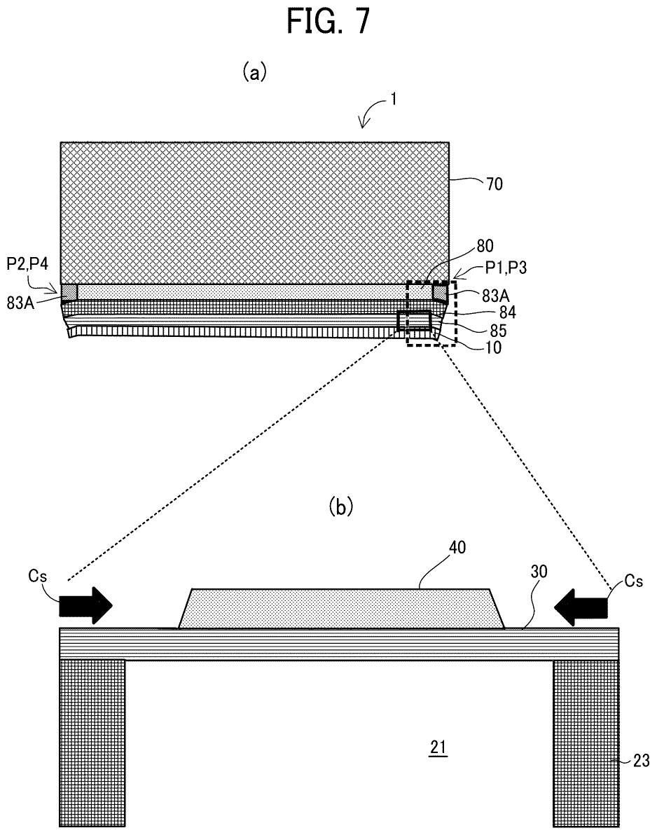

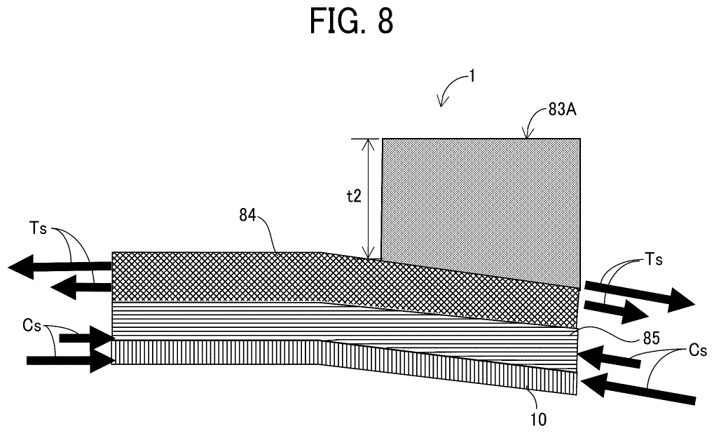

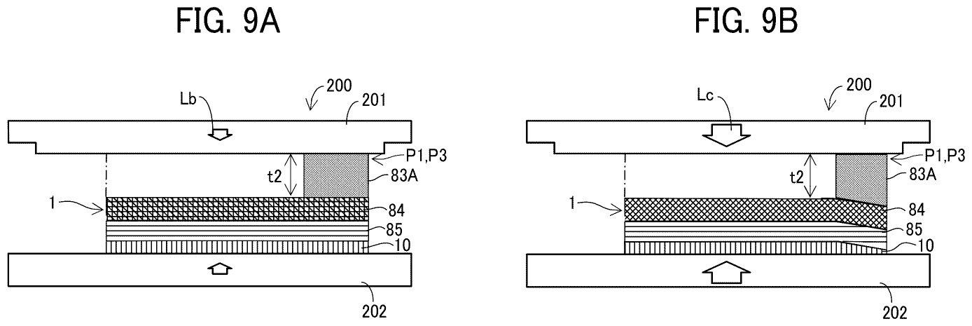

A description is given below of a first example of the liquid discharge head with reference to FIGS. 7 to 9B. A part (a) of FIG. 7 is a cross-sectional view of the first example of the liquid discharge head, and a part (b) of FIG. 7 is an enlarged cross-sectional view of a piezoelectric element substrate and the surroundings thereof, enclosed by the solid rectangular frame in the part (a). FIG. 8 is an enlarged cross-sectional view of a portion of the first example enclosed by the dashed rectangular frame in the part (a) of FIG. 7, when the corner adhesive is cured in a shape. FIGS. 9A and 9B are cross-sectional diagrams illustrating processes of manufacturing the first example of the liquid discharge head.

Corner adhesives 83A are disposed at the four corners P1 to P4 inside the outer periphery of a liquid discharge head 1 in FIGS. 7 to 9B. The corner adhesives 83A are indicated by fine crosshatching, which depicts the shape of the corner adhesive 83A cured by the irradiation of UV light, in FIGS. 7 to 9B. Illustrations of the thermosetting adhesives other than the corner adhesive 83A (i.e., the UV curable adhesive) of examples of the liquid discharge head 1, including the first example illustrated in FIGS. 7 to 9B, are intentionally omitted for the sake of simplicity of the drawings, as well as the comparative example.

The first example of the liquid discharge head 1 illustrated in the part (a) of FIG. 7 is different from the liquid discharge head 101 according to the comparative example illustrated in FIGS. 3 to 5B in that, instead of the corner adhesives 83, the corner adhesives 83A are disposed at the four corners P1 to P4, and both left and right ends of the corner adhesives 83A in the part (a) of FIG. 7 project in the ink discharge direction of the nozzle substrate 10. The UV curable adhesive becomes the corner adhesive 83A, indicated by fine crosshatching, after being cured by the irradiation of UV light.

The first example is different from the comparative example in that a thickness t2 of the corner adhesive 83A after curing is thicker than the thickness t1 of the corner adhesive 83 according to the comparative example after curing. The first example and the comparative example are similar in that the UV curable adhesive made of the same material before curing, which becomes the corner adhesive 83 and the corner adhesive 83A after being cured by the irradiation of UV light, is used.

To obtain the cured corner adhesive 83A having the thickness t2 larger than the thickness t1 of the corner adhesive 83 according to the comparative example, the following measures are taken when the UV curable adhesive made of the same material as the corner adhesive 83 according to the comparative example is used and the load applying device 200 similar to the comparative example illustrated in FIGS. 5A and 5B is used.

In the first example, as indicated by the thick arrows in the part (b) of FIG. 7, the corner adhesive 83A obtained by the process described later causes the strong compressive stresses Cs indicated by the thick arrows in the part (b) of FIG. 7 to be applied to the diaphragms 30 of the piezoelectric elements 40 disposed on the end portions of the piezoelectric element substrate 85, compared to the comparative example illustrated in the part (b) of FIG. 6.

As illustrated in the enlarged cross-sectional view of FIG. 8, the projecting end portion of the corner adhesive 83A, which is the cured UV curable adhesive, causes outward tensile stresses Ts indicated by arrows to be generated in the damper 84. Further, the inward compressive stresses Cs indicated by the arrows thicker than those in the comparative example are generated in the piezoelectric element substrate 85, and the large compressive stresses Cs indicated by the arrows thicker than those in the comparative example are generated in the nozzle substrate 10.

Thus, the projecting end portion causes large compressive stresses Cs indicated by the thick arrows to be applied to the piezoelectric element substrate 85 including the diaphragm 30 as compared with the comparative example.

A detailed description is given below of the first example with reference to FIGS. 9A and 9B. In the first example, in the fourth step described above, when the uncured corner adhesives 83A applied to the four corners P1 to P4 of the common channel substrate 70 are temporarily fixed, the liquid discharge head 1, during manufacturing, having the uncured corner adhesives 83A is placed and attached between the upper stage 201 and the lower stage 202 as illustrated in FIG. 9A, and the same load applying device 200 as illustrated in FIGS. 5A and 5B applies a load to the liquid discharge head 1. The load at this time is, for example, 30 N, which is a relatively weak load, as compared with the strong load, for example, 100 N, applied in the comparative example.

As described above, in the first example, in the process of applying a load before the corner adhesive 83A is cured by the irradiation of UV light, a load Lb, e.g., 30 N, indicated by the white thin arrows, which indicate a load weaker than, for example, 100 N applied in the comparative example, is applied to the uncured corner adhesive 83A in FIG. 9A. Since the load weaker than that in the comparative example is applied to the uncured corner adhesive 83A as illustrated in FIG. 9A, the compression amount of the uncured corner adhesive 83A is smaller than that in the comparative example. As a result, the thickness t2 of the uncured corner adhesive 83A can be made thicker than the thickness t1 in the comparative example (i.e., t2>t1). In this state, the corner adhesives 83A applied to the four corners P1 to P4 are instantly cured by irradiating the uncured corner adhesive 83A having the thickness t2, which is thicker than the thickness t1, with UV light.

In the elapsed time from FIG. 9A to FIG. 9B, a load Lc indicated by the white thick arrows, which is stronger than that illustrated in FIG. 9A, e.g., 100 N larger than 30 N, is applied to the corner adhesive 83A cured with the thickness t2 between the upper stage 201 and the lower stage 202. At this time, the corner adhesive 83A has been cured with the thickness t2, and the corner adhesive 83A is not compressed even by the strong load Lc.

As illustrated in FIG. 9B, when the strong load Lc indicated by the thick white arrows is applied, the peripheral end portion (the right ends of the damper 84, the piezoelectric element substrate 85, and the nozzle substrate 10) other than the corner adhesive 83A is strongly pressed obliquely downward to the right by the corner adhesive 83A that has already been cured. Thus, as illustrated in FIG. 9B, the shape of the corner adhesive 83A does not change; in other words, a thick portion of the liquid discharge head 1 thickened by the corner adhesive 83A (the right ends of the damper 84, the piezoelectric element substrate 85, and the nozzle substrate 10) projects in the ink discharge direction downward in FIG. 9B.

The corner adhesive 83A is pressed against the four corners P1 to P4 of the piezoelectric element substrate 85, and thus the corner adhesive 83A obtained by the process of FIG. 9B has a shape projecting (or bending) in the discharge direction toward the nozzle substrate 10 in perspective view or cross-sectional view. Such a shape may be referred to as a projecting portion or a bending portion. The right ends of the damper 84, the piezoelectric element substrate 85, and the nozzle substrate 10 are strongly pressed obliquely downward to the right in FIG. 9B and permanently deformed by the shape of the lower end portion of the corner adhesive 83A bonded and adhered in this state (the projecting shape inclined in the right oblique downward direction illustrated in FIG. 9B). Thus, the bending portions are inclined toward each ends of the piezoelectric element substrate 85 in the discharge direction.

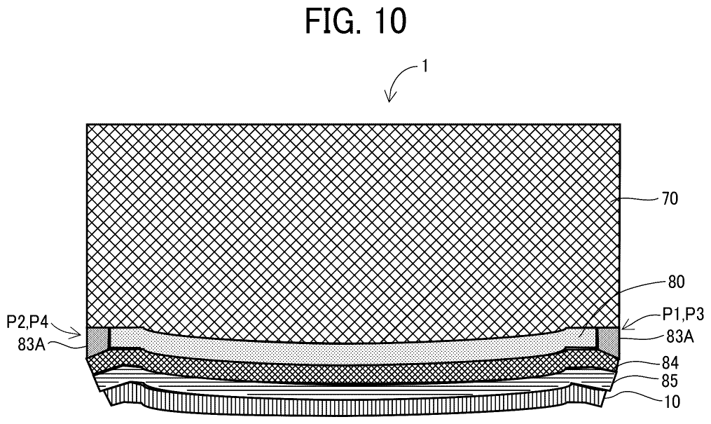

With reference to FIG. 10, a description is given below of the warpage of the cross section of the first example of the liquid discharge head 1. As illustrated in FIG. 10, the liquid discharge head 1 in the completed state is warped in cross section such that the central portion including the center of the nozzle substrate 10 and other substrates projects in the discharge direction downward in FIG. 10, and the end portion of the cured corner adhesives 83A at the four corners P1 to P4 of the common channel substrate 70 also projects (bends) in the discharge direction downward in FIG. 10. When the nozzle substrate 10 has a shape projecting downward, tensile stress is applied to the lower surface of the diaphragm 30, but the entire actuator component is compressed due to the contraction of the common channel substrate 70, which is a resin material member, and thus compressive stress is applied to the center in total.

Similarly to the liquid discharge head 101 according to the comparative example described above, in the first example of the liquid discharge head 1, the thermosetting adhesive applied between the opposed faces of the respective members (the piezoelectric element substrate 85, the damper 84, the damper holding substrate 80, and the common channel substrate 70) constructing the liquid discharge head 1 is heated while the strong load is applied to the thermosetting adhesives to cure the thermosetting adhesive. Due to the difference in linear expansion coefficient between the resin material member and the silicon material member generated at this time, the liquid discharge head 1 after curing also has residual stress. Even in the liquid discharge head 1 to be completed, the central portion of the nozzle substrate 10 and other substrates is distorted into a shape projecting downward due to the residual compressive stress similar to that of the liquid discharge head 101.

In the first example of the liquid discharge head 1, if no measures are taken, the diaphragm 30 in the piezoelectric element substrate 85 is loosened when the piezoelectric element substrate 85, which is the silicon material member, receives the compressive stress. Accordingly, the displacement of the piezoelectric element 40 increases as compared to when the piezoelectric element substrate 85 does not receive the compressive stress, and thus the ink discharge speed increases, similarly to the liquid discharge head 101 according to the comparative example.

However, in the first example of the liquid discharge head 1, in the process before the thermosetting adhesive is cured, the measures for reducing the stress difference between the central portion of the diaphragm 30 in the piezoelectric element substrate 85 and the end portion of the piezoelectric element substrate 85 are taken as described above. In other words, in the first example, by making a unique contrivance when curing the corner adhesive 83A at the four corners P1 to P4 of the common channel substrate 70, the end portions are formed into a shape projecting in the ink discharge direction as a result. Thus, the compressive stress is applied to the diaphragm at the end portions to reduce the difference in stresses between the central portion and the end portions. Accordingly, the liquid discharge head 1 as a whole can reduce the variations in the ink discharge speed.

As described above, in the first example of the liquid discharge head 1, the difference in the ink discharge speed between the central portion and the end portions of the liquid discharge head 1 can be reduced.

### Second Example

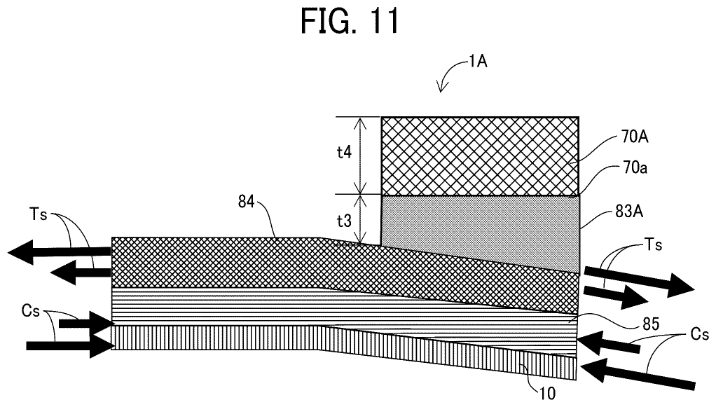

A description is given below of a second example of a liquid discharge head 1A with reference to FIG. 11. FIG. 11 is a schematic enlarged cross-sectional view of a portion of a second example of the liquid discharge head.

A second example of a liquid discharge head 1A illustrated in FIG. 11 is different from the first example of the liquid discharge head 1 illustrated in FIGS. 7 to 10 in that the liquid discharge head A1 includes the corner adhesives 83A having a reduced thickness t3 instead of the thickness t2 of the corner adhesives 83A disposed at the four corners P1 to P4, and includes a common channel substrate 70A provided with a projecting-shaped adhesive application portion 70a instead of the common channel substrate 70.

Similarly to the first example, the second example of the liquid discharge head 1A also includes the corner adhesives 83A at the four corners P1 to P4. The corner adhesives 83A are cured by the irradiation of UV light, and the shape of the corner adhesives 83A at the four corners P1 to P4 of the common channel substrate 70A projects in the ink discharge direction.

In the second example of the liquid discharge head 1A, the projecting end portion causes large compressive stresses Cs indicated by the thick arrows directing inward to be applied to the piezoelectric element substrate 85 including the diaphragm 30 as compared with the comparative example, similarly to FIG. 7.

In the second example of liquid discharge head 1A, the corner adhesives 83A cause the four corners and the central portion of the piezoelectric element substrate 85 to project toward the nozzle substrate 10 in perspective view or cross-sectional view (refer to claim 2).

As described above, in the second example of the liquid discharge head 1A, the difference in the ink discharge speed between the central portion and the end portion of the liquid discharge head 1A can be reduced.

### Third Example

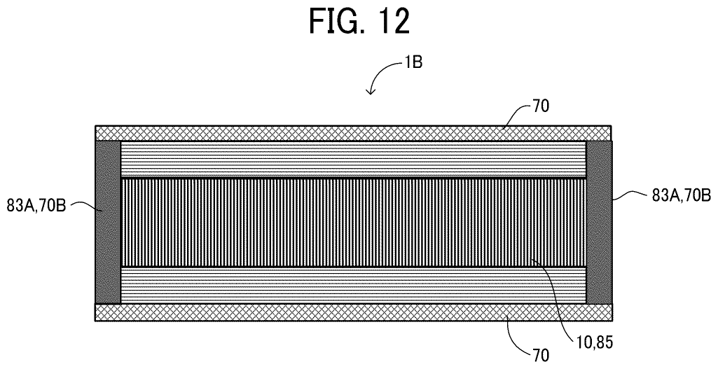

A description is given below of a third example of a liquid discharge head 1B with reference to FIG. 12. FIG. 12 is a bottom view of the third example of the liquid discharge head 1B as viewed from the nozzle substrate side of the liquid discharge head 1B in a discharge direction. In the above-described first and second examples, the corner adhesives 83A are disposed at the four corners P1 to P4 of the common channel substrate 70 and the piezoelectric element substrate 85, but the application portion of the corner adhesives 83A is not limited thereto, and a configuration of the third example may be employed.

In the third example, as illustrated in FIG. 12, the liquid discharge head 1B has projections 70B of the common channel substrate 70 (may be referred to as a “common channel substrate projections 70B”) having the projecting shape similar to the cross-sectional shape illustrated in FIG. 11 and the corner adhesives 83A having the projecting shape similar to the cross-sectional shape illustrated in FIG. 8 along the short sides of the common channel substrate 70 on both the left and right ends in FIG. 12. In other words, short side portions, extending in the transverse direction at both ends of the piezoelectric element substrate in the longitudinal direction, project (bend) in the discharge direction toward the nozzle plate.

The third example is effective in a case where the ink discharge speed discharged from nozzles arranged in the transverse direction other than the four corners located at the ends is increased depending on the arrangement of the piezoelectric elements 40 in the plane and the shapes of other components.

As illustrated in FIG. 12, the corner adhesive 83A applied to the common channel substrate projections 70B and the short side portion is disposed outside the region where the ink channel is formed and the nozzles 11 are formed in the nozzle substrate 10 so as not to interfere with the region and the nozzles 11.

In the third example of the liquid discharge head 1B, similarly to the first example and the second example, the projecting shape of the common channel substrate projections 70B and the corner adhesives 83A along the short sides of the common channel substrate 70 on both the left and right ends in FIG. 12 causes large compressive stresses Cs indicated by the thick arrows directing inward to be applied to the piezoelectric element substrate 85 including the diaphragm 30 as compared with the comparative example, similarly to FIG. 7.

In the third example of the liquid discharge head 1B, the short side portions of the piezoelectric element substrate 85 at the position corresponding to the corner adhesives 83A have the projecting shape due to the presence of the common channel substrate projections 70B and the corner adhesives 83A. The central portion of the piezoelectric element substrate 85 is deformed due to the difference in linear expansion coefficient between the common channel substrate 70 and the silicon material member (the laminated substrate members such as the piezoelectric element substrate 85 and the damper holding substrate 80), and thus the central portion has the projecting shape. Accordingly, the short side portions at the position corresponding to the corner adhesives 83A and the central portion of the piezoelectric element substrate 85 project (bend) in the discharge direction toward the nozzle substrate 10 in perspective view or cross-sectional view (refer to claim 3).

As described above, in the third example of the liquid discharge head 1B, the difference in the ink discharge speed between the central portion and the end portions of the liquid discharge head 1B can be reduced.

In each of the above-described examples, the corner adhesive 83A joins and bonds the common channel substrate 70 and the damper 84 but is not limited depending on the structure of the laminated substrate members. For example, the common channel substrate 70 and the piezoelectric element substrate 85 may be bonded to each other with the corners of the damper 84 removed, or the common channel substrate 70 and the damper holding substrate 80 may be bonded to each other with the corners of the damper holding substrate 80 partially thinned (refer to claim 1).

In each of the above examples, in order to apply a compressive stress to the diaphragm 30, the thickness of the member between the diaphragm 30 and the common channel substrate 70 is preferably larger than the thickness of the member from the diaphragm 30 to the nozzle substrate 10 (refer to claim 7). In other words, a thickness from a second face of the functional substrate to a third face of the diaphragm on which the multiple piezoelectric elements are disposed is larger than a thickness from the third face of the diaphragm to a surface of the nozzle plate from which the liquid is discharged.

The above embodiments of the present disclosure substantially include, for example, the following aspects and effects.

According to Aspect 1, a liquid discharge head such as the liquid discharge head 1 includes a nozzle substrate such as the nozzle substrate 10 having multiple nozzles such as the nozzles 11, multiple individual liquid chambers such as the individual liquid chambers 21 corresponding to the multiple nozzles, a diaphragm such as the diaphragm 30 formed on a surface of the individual liquid chambers facing the nozzle substrate, a piezoelectric element substrate such as the piezoelectric element substrate 85 having multiple piezoelectric elements such as the piezoelectric elements 40 formed on the diaphragm (i.e., the third face) and corresponding to the multiple individual liquid chambers, the functional substrate such as the damper 84 and the damper holding substrate 80 including one or multiple substrates bonded to a side of the piezoelectric element substrate opposite to the nozzle substrate, and a common channel substrate such as the common channel substrate 70 made of a material having a larger linear expansion coefficient than the piezoelectric element substrate, bonded to a side of the functional substrate (i.e., the second face) opposite to a surface bonded to the piezoelectric element substrate. Four corners such as corner adhesives 83A disposed at least at four corners P1 to P4 of the piezoelectric element substrate have a shape projecting toward the nozzle substrate.

In other words, a liquid discharge head includes a nozzle plate, a piezoelectric element substrate, a functional substrate, and a common channel substrate. The nozzle plate has multiple nozzles to discharge a liquid in a discharge direction. The piezoelectric element substrate is bonded to the nozzle plate. The piezoelectric element substrate includes: multiple individual chambers respectively communicating with the multiple nozzles; a diaphragm facing the multiple individual chambers; and multiple piezoelectric elements on the diaphragm. The multiple piezoelectric elements respectively correspond to the multiple individual chambers. The piezoelectric element substrate has: a first linear expansion coefficient; and bending portions disposed at each end or at each corner of the piezoelectric element substrate. The bending portions bend in the discharge direction. The functional substrate has a first face bonded to the piezoelectric element substrate. The common channel substrate is bonded to a second face opposite to the first face of the functional substrate. The common channel substrate has a second linear expansion coefficient larger than the first linear expansion coefficient of the piezoelectric element substrate.

With this configuration, according to Aspect 1, a liquid discharge head can be provided that reduces the difference in the discharge speed of liquid between the central portion and the end portions of the liquid discharge head.

According to Aspect 2, in the liquid discharge head of Aspect 1, the four corners and a central portion of the piezoelectric element substrate have a shape projecting toward the nozzle substrate in the liquid discharge head 1B.

In other words, the piezoelectric element substrate further has a central bending portion bending in the discharge direction at a center of the piezoelectric element substrate.

According to Aspect 3, in the liquid discharge head of Aspect 1 or 2, a short side portion and a central portion of the piezoelectric element substrate have a shape projecting toward the nozzle substrate in the liquid discharge head 1B.

In other words, the multiple nozzles are arrayed on the nozzle plate in a longitudinal direction of the piezoelectric element substrate. The piezoelectric element substrate further has a central bending portion and short side portions. The central bending portion is disposed at a center of the piezoelectric element substrate. The central bending portion bends in the discharge direction. The short side portions are disposed at both ends of the piezoelectric element substrate in the longitudinal direction. The short side portions extend in a transverse direction orthogonal to the longitudinal direction. The short side portions bend in the discharge direction.

According to Aspect 4, in the liquid discharge head of any one of Aspects 1 to 3, a material of the piezoelectric element substrate is silicon, and a material of the common channel substrate is resin.

In other words, the piezoelectric element substrate includes silicon, and the common channel substrate includes resin.

According to Aspect 5, in the liquid discharge head of any one of Aspects 1 to 4, the piezoelectric element substrate and the functional substrate, and the functional substrate and the common channel substrate are bonded to each other with an adhesive. The four corners of the functional substrate and the common channel substrate are bonded to each other with an adhesive, such as a UV curable adhesive, different from that in a region where a liquid channel is formed.

In other words, the piezoelectric element substrate and the functional substrate are bonded to each other with a first type of adhesive. The functional substrate and the common channel substrate are bonded to each other with the first type of adhesive. Four corners of the functional substrate and four corners of the common channel substrate are bonded to each other with a second type of adhesive different from the first type of adhesive.

According to Aspect 6, in the liquid discharge head of any one of Aspects 1 to 5, the four corners of the common channel substrate have a shape projecting toward the functional substrate.

In other words, four corners of the common channel substrate bend in the discharge direction toward the functional substrate.

According to Aspect 7, in the liquid discharge head of any one of Aspects 1 to 6, a thickness of a member between the diaphragm and the common channel substrate is larger than a thickness of a member from the diaphragm to the nozzle substrate.

In other words, a thickness from the second face of the functional substrate to a third face of the diaphragm on which the multiple piezoelectric elements are disposed is larger than a thickness from the third face of the diaphragm to a surface of the nozzle plate from which the liquid is discharged.

According to Aspect 8, a liquid discharge unit includes the liquid discharge head, such as one of the liquid discharge heads 1, 1A, and 1B, according to any one of Aspects 1 to 7.

In other words, a liquid discharge unit includes multiple liquid discharge heads including the liquid discharge head according to any one of Aspects 1 to 7, to discharge a liquid.

According to Aspect 9, a liquid discharge apparatus includes the liquid discharge head, such as one of the liquid discharge heads 1, 1A, and 1B, according to any one of Aspects 1 to 7, or the liquid discharge unit according to Aspect 8.

In other words, a liquid discharge apparatus includes: the liquid discharge head according to any one of Aspects 1 to 7, to discharge a liquid onto a medium; and a conveyor to convey the medium to the liquid discharge head.

According to Aspect 10, a liquid discharge apparatus includes: the liquid discharge unit according to Aspect 8, to discharge the liquid onto a medium; and a conveyor to convey the medium to the liquid discharge unit.

According to Aspect 11, in the liquid discharge head according to Aspect 1, the multiple nozzles are configured to discharge a liquid from the multiple nozzles. The bending portions are inclined toward each end of the piezoelectric element substrate in the discharge direction.

According to Aspect 12, a head manufacturing method includes: applying adhesive on four corners of a common channel substrate; laminating the common channel substrate on a functional substrate; laminating the functional substrate on a piezoelectric element substrate; laminating the piezoelectric element substrate on a nozzle plate; applying a first load to a lamination of the common channel substrate, the functional substrate, the piezoelectric element substrate, and the nozzle plate to bond the of the common channel substrate, the functional substrate, the piezoelectric element substrate, and the nozzle plate with the adhesive; and applying a second load larger than the first load to the lamination after applying the first load to the lamination to deform each end of the piezoelectric element substrate to form bending portions bending toward the nozzle plate.

According to Aspect 13, in the head manufacturing method according to Aspect 12, the applying the second load deforms each of four corners of the piezoelectric element substrate to form the bending portions at each of the four corners.

A description is given below of a liquid discharge apparatus including any one of the liquid discharge heads 1, 1A, and 1B described above.

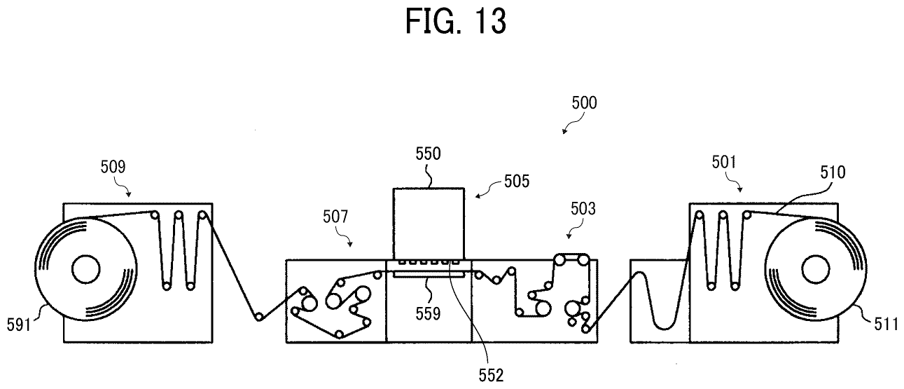

As illustrated in FIG. 13, a printer 500 serving as the liquid discharge apparatus includes a feeder 501 to feed a continuous medium 510 as a recording medium (i.e., a medium), a guide conveyor 503 (i.e., a conveyor) to guide and convey the continuous medium 510, fed from the feeder 501, to a printing unit 505. The printer 500 further includes the printing unit 505 to discharge a liquid onto the continuous medium 510 to form an image on the continuous medium 510, a dryer 507 to dry the continuous medium 510 to which the liquid adheres, and a carrier 509 to feed the dried continuous medium 510 outward.

The continuous medium 510 is fed from a winding roller 511 of the feeder 501, guided and conveyed with rollers of the feeder 501, the guide conveyor 503, the dryer 507, and the carrier 509, and wound around a take-up roller 591 of the carrier 509. These rollers serve as a conveyor to convey the continuous medium 510. In the printing unit 505, the continuous medium 510 is conveyed on a conveyance guide 559 so as to face a head unit 550 as a liquid discharge unit. The head unit 550 discharges a liquid onto the continuous medium 510 to print an image.

The printer 500 includes liquid discharge units 100 described above (see FIGS. 1 and 2) in the head unit 550. The liquid discharge units 100 are mounted on a common base 552. Each of the liquid discharge units 100 includes head arrays each including the liquid discharge heads 1 arranged in a head array direction perpendicular to a conveyance direction of the continuous medium 510. Head arrays of one liquid discharge unit 100 discharge liquid of the same color. Similarly, other head arrays of another liquid discharge unit 100 are grouped as one set and discharge liquid of the same desired color.

An overview including definitions of a liquid discharge head, a liquid discharge unit, and a liquid discharge apparatus will be described below.

In the present disclosure, the term “liquid discharge head (head)” used herein is a functional component to discharge liquid through the nozzles. The property of liquid to be discharged from the liquid discharge head is not limited as long as the liquid has a viscosity or surface tension to be discharged from the liquid discharge head. However, preferably, the viscosity of the liquid is not greater than 30 millipascal-second (mPa·s) under ordinary temperature and ordinary pressure or by heating or cooling. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; or an edible material, such as a natural colorant. Such a solution, a suspension, or an emulsion can be used for, e.g., inkjet ink, surface treatment solution, or a material solution for three-dimensional fabrication.

Examples of an energy source for generating energy to discharge the liquid include a piezoelectric actuator (a laminated piezoelectric element or a thin-film piezoelectric element), a thermal actuator that employs a thermoelectric transducer, such as a thermal resistor, and an electrostatic actuator including a diaphragm and opposed electrodes.

The “liquid discharge unit” is an assembly of parts relating to liquid discharge. The term “liquid discharge unit” represents a structure including the liquid discharge head and a functional component(s) or mechanism(s) combined with the liquid discharge head as a single unit. For example, the “liquid discharge unit” includes a combination of the liquid discharge head with at least one of a head tank, a carriage, a supply mechanism, a maintenance mechanism, a main-scanning moving mechanism, or a liquid circulation device.

The above integration may be achieved by, for example, a combination in which the liquid discharge head and a functional part(s) are secured to each other through, e.g., fastening, bonding, or engaging, and a combination in which one of the liquid discharge head and a functional part(s) is movably held by another. The liquid discharge head may be detachably attached to the functional part(s) or mechanism(s) each other.

The liquid discharge head and the head tank may be assembled, or the liquid discharge head and the head tank may be coupled (connected) to each other via, for example, a tube to form the liquid discharge unit as a single unit. A unit including a filter may further be added to a portion between the head tank and the liquid discharge head of the liquid discharge unit.

The liquid discharge unit may be an integrated unit in which the liquid discharge head and the carriage are integrated as a single unit, or the liquid discharge head, the carriage, and the main-scanning moving mechanism are integrated as a single unit. As yet another example, the liquid discharge unit is a unit in which the liquid discharge head and the scanning moving mechanism are combined into a single unit. The liquid discharge head is movably held by a guide that is a part of the scanning moving mechanism.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit. Further, in another example, the liquid discharge unit includes a tube connected to the liquid discharge head mounting the head tank or the channel component so that the liquid discharge head and the supply mechanism are integrated as a single unit. Through the tube, the liquid in a liquid storage source is supplied to the liquid discharge head.

The main-scanning moving mechanism may be a guide only. The supply mechanism may be a tube(s) only or a loading unit only.

Although the liquid discharge unit includes the liquid discharge head as described above, examples of the liquid discharge unit include a head module and the head unit including the above-described liquid discharge head, with which the above-described functional components or mechanisms are combined to form a single unit.

In the present disclosure, the term “liquid discharge apparatus” drives the liquid discharge head to discharge liquid. The term “liquid discharge apparatus” used herein also represents an apparatus including the liquid discharge head, the liquid discharge unit, the head module, or the head unit to drive the liquid discharge head to discharge liquid. The liquid discharge apparatus used herein includes, in addition to apparatuses to discharge liquid to a medium onto which liquid can adhere, apparatuses to discharge the liquid into gas (air) or a different liquid.

The liquid discharge apparatus may further include devices relating to feeding, conveying, and ejecting of the medium onto which liquid can adhere and also include a pretreatment device and an aftertreatment device.

The liquid discharge apparatus may be, for example, an image forming apparatus to form an image on a recording medium by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The medium onto which liquid can adhere described above represents a medium onto which liquid is at least temporarily adhered, a medium onto which liquid is adhered and fixed, or a medium into which liquid adheres and permeates. Examples of the medium onto which liquid can adhere include recording medium, such as paper sheet, recording paper, recording sheet of paper, film, and cloth, electronic components, such as electronic substrate and piezoelectric element, and media, such as powder layer, organ model, and testing cell. The medium onto which liquid can adhere includes any material to which liquid adheres, unless otherwise specified.

Examples of the material for the medium onto which liquid can adhere include any materials to which liquid can adhere even temporarily, such as paper, thread, fiber, fabric, leather, metal, plastic, glass, wood, and ceramic.

The liquid discharge apparatus moves the liquid discharge head and the medium onto which liquid can adhere relative to each other. Which of the liquid discharge head or the medium onto which liquid can adhere is moved is not limited. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The above-described embodiments are illustrative and do not limit the present disclosure. Thus, numerous additional modifications and variations are possible in light of the above teachings, unless otherwise specified.

The advantages achieved by the embodiments described above are examples and therefore are not limited to those described above.

The present applicant has proposed another example to solve the similar situation. In such an example, to reduce the difference in liquid discharge speed between the central portion and the end portion of the liquid discharge head, the common channel substrate (frame member) is hollowed to form void portions to reduce the residual stress of the liquid discharge head generated due to the difference in linear expansion coefficient.

However, as compared with the above-described examples, such an example does not solve the distribution tendency that the liquid discharge speed in the central portion of the liquid discharge head is high and the liquid discharge speed in the end portion of the liquid discharge head is low.

As described above, according to one aspect of the present disclosure, a liquid discharge head can be provided that reduces the difference in discharge speed between the central portion and the end portion of the liquid discharge head.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having multiple nozzles to discharge a liquid in a discharge direction;
a piezoelectric element substrate bonded to the nozzle plate, the piezoelectric element substrate including:
multiple individual chambers respectively communicating with the multiple nozzles;
a diaphragm facing the multiple individual chambers; and
multiple piezoelectric elements on the diaphragm, the multiple piezoelectric elements respectively corresponding to the multiple individual chambers,
the piezoelectric element substrate having:
a first linear expansion coefficient; and
bending portions disposed at each end or at each corner of the piezoelectric element substrate, the bending portions bending in the discharge direction;
a functional substrate having a first face bonded to the piezoelectric element substrate; and
a common channel substrate bonded to a second face opposite to the first face of the functional substrate,
the common channel substrate having a second linear expansion coefficient larger than the first linear expansion coefficient of the piezoelectric element substrate.

2. The liquid discharge head according to claim 1,
wherein the piezoelectric element substrate further has a central bending portion bending in the discharge direction at a center of the piezoelectric element substrate.

3. The liquid discharge head according to claim 1,
wherein the multiple nozzles are arrayed on the nozzle plate in a longitudinal direction of the piezoelectric element substrate,
the piezoelectric element substrate further has:
a central bending portion at a center of the piezoelectric element substrate,
the central bending portion bending in the discharge direction; and
short side portions at both ends of the piezoelectric element substrate in the longitudinal direction,
the short side portions extending in a transverse direction orthogonal to the longitudinal direction, and
the short side portions bending in the discharge direction.

4. The liquid discharge head according to claim 1,
wherein the piezoelectric element substrate includes silicon, and
the common channel substrate includes resin.

5. The liquid discharge head according to claim 1,
wherein the piezoelectric element substrate and the functional substrate are bonded to each other with a first type of adhesive,
the functional substrate and the common channel substrate are bonded to each other with the first type of adhesive, and
four corners of the functional substrate and four corners of the common channel substrate are bonded to each other with a second type of adhesive different from the first type of adhesive.

6. The liquid discharge head according to claim 1,
wherein four corners of the common channel substrate bend in the discharge direction toward the functional substrate.

7. The liquid discharge head according to claim 1,
wherein a thickness from the second face of the functional substrate to a third face of the diaphragm on which the multiple piezoelectric elements are disposed is larger than a thickness from the third face of the diaphragm to a surface of the nozzle plate from which the liquid is discharged.

8. A liquid discharge unit comprising:
multiple liquid discharge heads including the liquid discharge head according to claim 1, to discharge a liquid.

9. A liquid discharge apparatus comprising:
the liquid discharge head according to claim 1, to discharge a liquid onto a medium; and
a conveyor to convey the medium to the liquid discharge head.

10. A liquid discharge apparatus comprising:
the liquid discharge unit according to claim 8, to discharge the liquid onto a medium; and
a conveyor to convey the medium to the liquid discharge unit.

11. The liquid discharge head according to claim 1,
wherein the multiple nozzles are configured to discharge a liquid from the multiple nozzles;
the bending portions are inclined toward each end of the piezoelectric element substrate in the discharge direction.

12. A head manufacturing method comprising:
applying adhesive on four corners of a common channel substrate;
laminating the common channel substrate on a functional substrate;
laminating the functional substrate on a piezoelectric element substrate;
laminating the piezoelectric element substrate on a nozzle plate;
applying a first load to a lamination of the common channel substrate, the functional substrate, the piezoelectric element substrate, and the nozzle plate to bond the of the common channel substrate, the functional substrate, the piezoelectric element substrate, and the nozzle plate with the adhesive; and
applying a second load larger than the first load to the lamination after applying the first load to the lamination to deform each end of the piezoelectric element substrate to form bending portions bending toward the nozzle plate.

13. The head manufacturing method according to claim 12,
wherein the applying the second load deforms each of four corners of the piezoelectric element substrate to form the bending portions at each of the four corners.
